(19) United States
(12) Patent Application Publication
(10) Pub. No.: US 2016/0112389 A1
(43) Pub. Date: Apr. 21, 2016

(54) SECURE TRANSFER OF USER AUTHENTICATION CREDENTIALS BETWEEN DEVICES

(71) Applicant: Laurent Bortolamiol, San Jose, CA (US)

(72) Inventor: Laurent Bortolamiol, San Jose, CA (US)

(21) Appl. No.: 14/515,290

(22) Filed: Oct. 15, 2014

(51) Int. Cl. H04L 29/06; H04L 29/08

(52) U.S. Cl. CPC H04L 63/08; H04L 67/10; H04L 67/42

(57) ABSTRACT

An embodiment for the secure transfer of authentication credentials between devices is disclosed. An embodiment for the restoration of authentication credentials is also disclosed.

### TECHNICAL FIELD

A method and apparatus for the secure transfer of authentication credentials between devices are disclosed. A method and apparatus for the restoration of authentication credentials are also disclosed.

### BACKGROUND OF THE INVENTION

Web browsers and web sites are well-known. In recent years, the operators of web sites have become interested in obtaining as much data about each user as possible. For example, web sites often are designed to obtain demographic data from users, such as age, gender, geographic location, occupation, etc. Once a web server obtains such information, it can tailor the content of the web site based on that information.

For example, a web server (or an external advertising server) can tailor the content of advertisements to send to each user. The web server also can tailor other aspects of the web site to a particular user. For example, if the web server knows that a user likes NFL football, it can prioritize content about football to ensure that articles or blogs about football appear on the top of a web page when the user accesses the web site.

In prior art systems, if a user wished to have a customized web experience, the user needed to provide information to the web site, such as by setting up an account with the web site and filling out a profile form. Thereafter, the web site would associate that information with the user whenever the user logged into the site, which typically required the user to enter a name and password each time he or she accessed the site. This could be a cumbersome process for the user and prevents the user from experiencing a seamless web experience.

In U.S. patent application Ser. No. 13/891,812, “Automatic Transmission of User Profile Information to a Web Server,” filed on May 10, 2013, and which is incorporated by reference, the inventor and assignee of this application disclosed a mechanism by which a web server can obtain profile information about a user from a profile server without the user logging into the web site or web server. As part of that mechanism, a profile ID is stored on a user's device. That profile ID is an example of an authentication credential stored locally on a device.

What is further needed is a mechanism for securely transferring authentication credentials, including but not limited to the profile ID, between devices to allow a user to switch devices. What is further needed is a mechanism for restoring authentication credentials.

### SUMMARY OF THE INVENTION

The embodiments described herein comprise a secure method and apparatus for transferring credentials between devices without the user needing to provide a user name and password.

### BRIEF DESCRIPTION OF THE DRAWINGS

FIG. 1 depicts an embodiment of a system for transferring profile information.

FIG. 2 depicts additional detail of an embodiment of a system for transferring profile information.

FIG. 3 depicts an embodiment of a user interface for obtaining profile information.

FIG. 4 depicts another embodiment of a user interface for obtaining profile information.

FIG. 5 depicts a method for obtaining profile information and transferring that information to a web server.

FIG. 6 depicts an embodiment of a data structure for profile information.

FIG. 7. depicts a method of transferring profile information to a web server.

FIG. 8. depicts a web browser icon to indicate that profile information has been transferred.

FIG. 9. depicts a mobile device icon to indicate that profile information has been transferred.

FIG. 10 depicts a network enabled TV icon to indicate that profile information has been transferred.

FIG. 11 depicts a network enabled device icon to indicate that profile information has been transferred.

FIG. 12 depicts a mechanism for transferring profile information to a client.

FIG. 13 depicts the transfer of authentication credentials between devices that have access to the same resource server.

FIG. 14 depicts the transfer of authentication credentials from one device to another device through a resource server.

FIG. 15 depicts a device plug-in for storing and transferring authentication credentials.

FIG. 16 depicts an authentication process using authentication credentials stored on a device.

FIG. 17 depicts a device plug-in for storing and transferring authentication credentials.

### DETAILED DESCRIPTION OF THE PREFERRED EMBODIMENTS

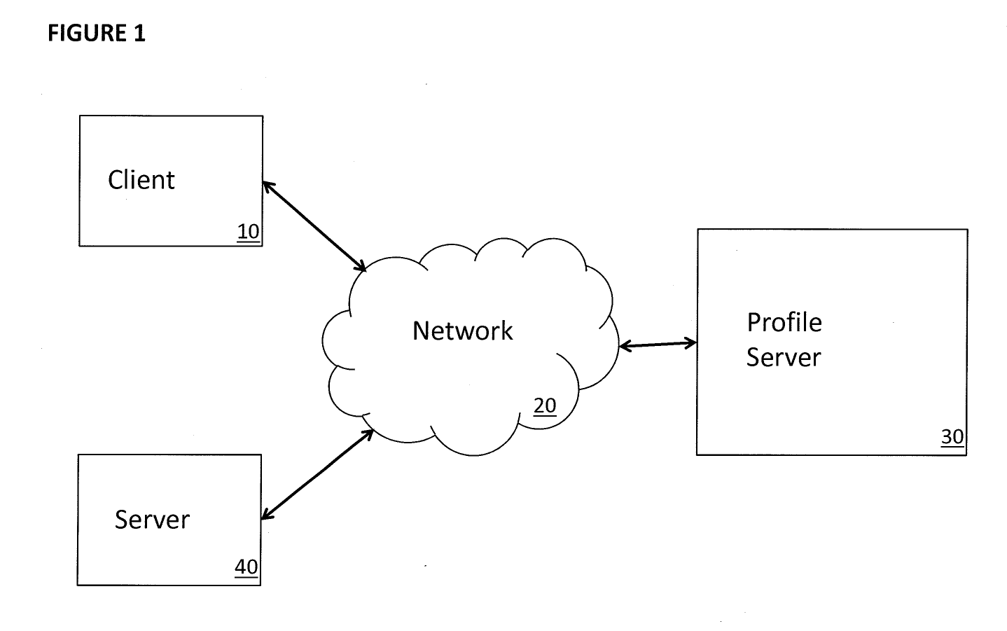

An embodiment is shown in FIG. 1. Client 10 is a computer, such as a desktop, notebook, mobile device, tablet, appliance, or any other type of computing device that is network enabled. Client 10 comprises one or more processors, memory, and non-volatile storage such as a hard disk drive or flash memory array. Client 10 is coupled to network 20. Network 20 can be any type of network, such as the Internet, and can be hardwired, wireless, or some combination of the two.

Server 40 is a computer that can serve files and/or data over network 20. Server 40 comprises one or more processors, memory, and non-volatile storage such as a hard disk drive or flash memory array. In this example, server 40 can operate a web server. In this configuration, client 10 can access a web site operated by server 40 over network 20.

Profile data server 30 also is a computer that can serve files and/or data over network 20. Profile data server 30 comprises one or more processors, memory, and non-volatile storage such as a hard disk drive or flash memory array. Profile data server 30 has unique role that will be discussed in greater detail in the figures that follow.

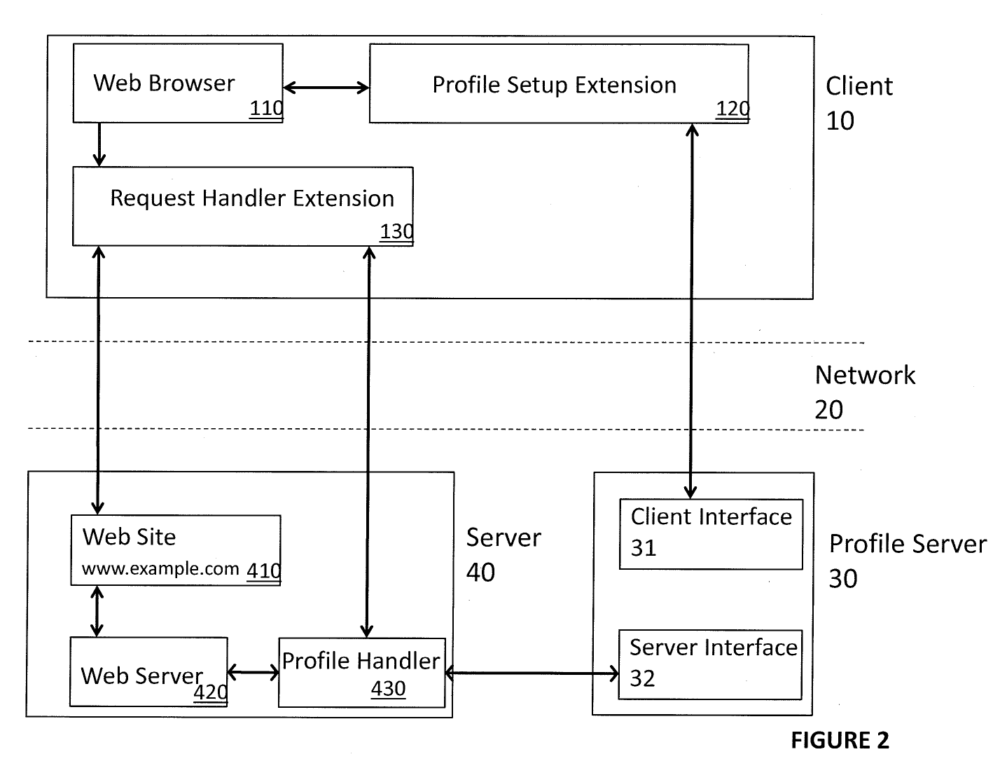

With reference to FIG. 2, client 10 optionally comprises web browser 110. Web browsers, such as Microsoft Internet Explorer and Google Chrome, are well-known in the art. Instead of a web browser 110, client 10 could comprise other software that facilitates network communication, such as a native mobile device application.

Client 10 further comprises request handler extension 130 and profile setup extension 120. Request handler extension 130 and profile setup extension 120 each are software modules comprising lines of code. Request handler extension 130 and profile setup extension 120 are executed by one or more of the processors of client 10. Request handler extension 130 and profile setup extension 120 can be modules that work in conjunction with web browser 110 (or other software), or in the alternative, they can be part of web browser 110 (or other software).

Server 40 comprises web server 420. Typically, web server 420 is a software application that hosts a web site 410 on the Internet or other network. Web site 410 can comprise, among other things, a set of HTML files and associated data stored within server 40. One of ordinary skill in the art will appreciate, however, that web server 420 is able to communicate with client 10 directly without using web site 410. One will also appreciate that web server 420 does not necessarily need to host a web site 410.

Server 40 further comprises profile handler 430. Profile handler 430 is a software module comprising lines of code. Profile handler 430 is executed by one or more of the processors of server 40. In its simplest form profile handler 430 can be a web page within web site 410 that is configured to look at requests received from Client 10 or other clients and to send any profile ID in those requests to profile server 30, and to then receive from profile server 30 any profile information associated with that profile ID.

Profile server 30 optionally comprises client interface 31 and server interface 32. Client interface 31 is a software module comprising lines of code to interact with profile setup extension 120 within client 10. Server interface 32 is a software module comprising lines of code to interact with profile handler 430.

Profile setup extension 120 optionally generates user interfaces for obtaining profile information from a particular user of client 10. For example, when web browser 110 is used for the first time profile setup extension 120 can ask the user questions and store the user's answers. Profile setup extension 120 also can do this periodically, or upon the occurrence of certain events (such as when client 10 visits a “registered web site” or interacts with a “registered web server,” discussed below, for the first time).

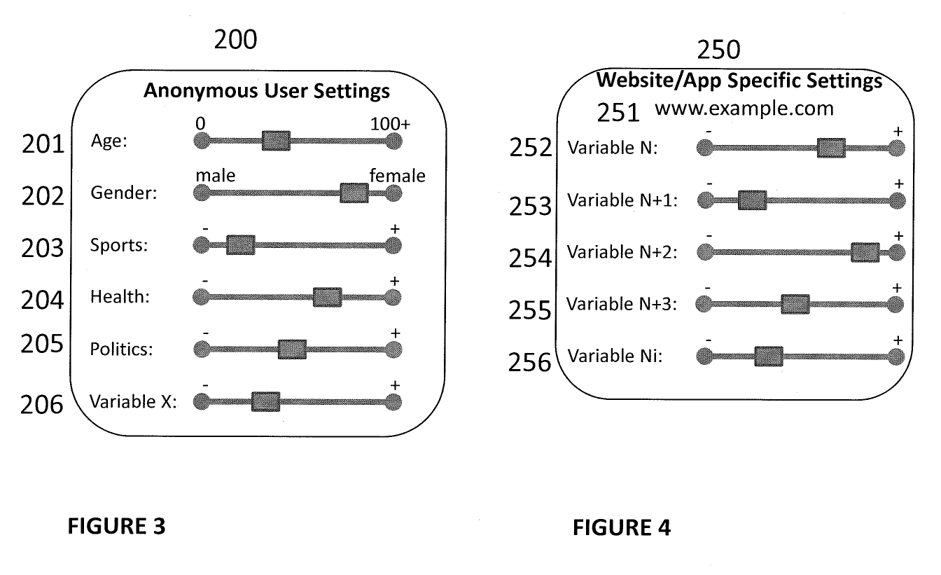

FIG. 3 depicts an exemplary user interface 200 that profile setup extension 120 can generate on client 10. In this example, user interface 200 obtains information about User 15 that is general in nature and might be of interest to many or all web site operators, which can be referred to as generic data 150. For example, most commercial web site operators are extremely interested in knowing the age and gender of users who access their web sites.

User interface 200 comprises a series of input devices (such as text boxes, buttons, pull-down menus, or sliding-scale devices, etc.) that enable User 15 to input profile information. For example, in this example, input device 201 obtains information about age, input device 202 obtains information about gender, input device 203 obtains information about sports, input device 204 obtains information about health, input device 205 obtains information about politics, and input device 206 obtains information about Category X (which can be any category of interest). The information obtained can be a number (as would be the case with input device 201 and age) or a selection from among options (as would be the case with input device 202 and gender) or can reflect the user's relative interest in a topic (as would be the case with input device 203 and sports).

FIG. 4 depicts another exemplary user interface 250 that profile setup extension 120 can generate on client 10. User interface 250 obtains information that is specifically requested by web server 420, which can be referred to as custom data 160. Profile handler 430 asks web server 420 for any profile information that it wishes to obtain from users. This can happen, for example, during a configuration step when web server 420 (or its operator) registers itself and/or web site 410 with profile server 30. During that configuration step, profile handler 430 will provide profile server 30 (optionally through server interface 32) with the profile information and categories for which it wishes to obtain custom data 160 (e.g., favorite NFL quarterback). Once this configuration step occurs, web site 410 can be referred to as registered web site 415 and web server 420 can be referred to as registered web server 425. User interface 250 displays the URL 251 of the website for which the information is being sought. User interface optionally can be displayed on client 10 when User 15 first visits a website corresponding to URL 251.

User interface 250 comprises a series of input devices that enable User 15 to input profile information specific to the website corresponding to URL 251. For example, input device 252 obtains information about Variable N, input device 253 obtains information about Variable N+1, input device 254 obtains information about Variable N+2, input device 255 obtains information about Variable N+3, and input device 256 obtains information about Variable N+i (where i can be any integer value). It is to be understood that other input devices can be displayed between input device 255 and input device 256 if i is greater than 4.

Once User 15 inputs data into profile setup extension 120, profile setup extension 120 will communicate with profile data server 30 (optionally through client interface 31). Profile data server 30 will obtain and store the user data from profile setup extension 120. Optionally, profile data server 30 comprises a relational database such as MySQL or a NoSQL database such as MongoDB, and the user data structure can be stored as a table where the key and user name are unique IDs associated with User 15.

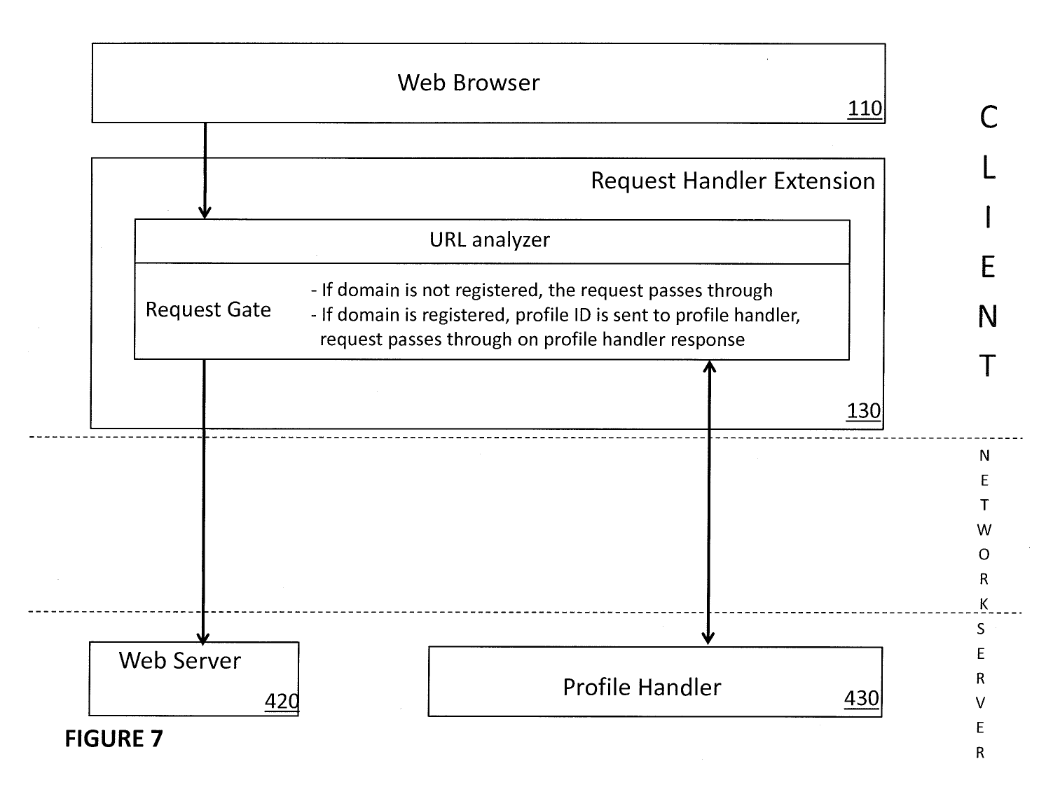

Thereafter, when User 15 operates web browser 110 to access web site 410 (here, located at www.example.com), request handler extension 130 will intercept that request and will communicate with profile handler 430 to determine if web site 410 is a registered web site 415. If it is not, then client 10 will access web site 410 as in the prior art. However, if web site 410 is a registered web site 415, then web server 420 will request and obtain profile information for that user from profile handler 430. In this manner, and without User 15 logging in or providing profile information to web server 420, web server 420 is able to obtain the user profile information. Web server 420 can then tailor the contents of web site 410 and/or its advertisements to User 15. This process is depicted in FIG. 7.

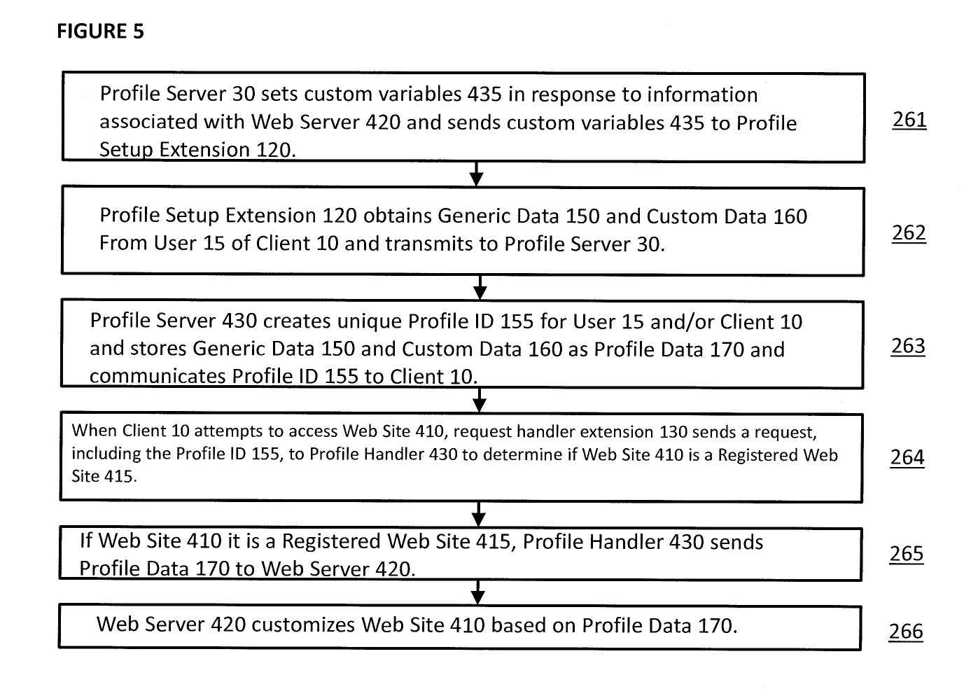

With reference now to FIG. 5, a method is depicted that is performed in conjunction with the embodiments described herein. Profile Server 30 sets custom variables 435 in response to information received from web server 420 during the configuration step and sends custom variables 435 to profile setup extension 120 (step 261). Profile setup extension 120 obtains generic data 150 and custom data 160 from User 15 of client 10 and transmits them to profile server 30 (step 262). Profile server 30 creates a unique Profile ID 155 for User 15 and/or client 10 and stores generic data 150 and custom data 160 as profile data 170 and communicates profile ID 155 to client 10 (step 263). When client 10 attempts to access web site 410, request handler extension 130 sends a request, including the Profile ID 155, to profile handler 430 to determine if web site 410 is a registered web site 415 (step 264). If it is a registered web site 415 (and/or if web server 420 is a registered web server 425), profile handler 430 sends profile data 170 to web server 420 (step 265). Web server 420 customizes web site 410 (or other content) based on profile data 170 (step 266).

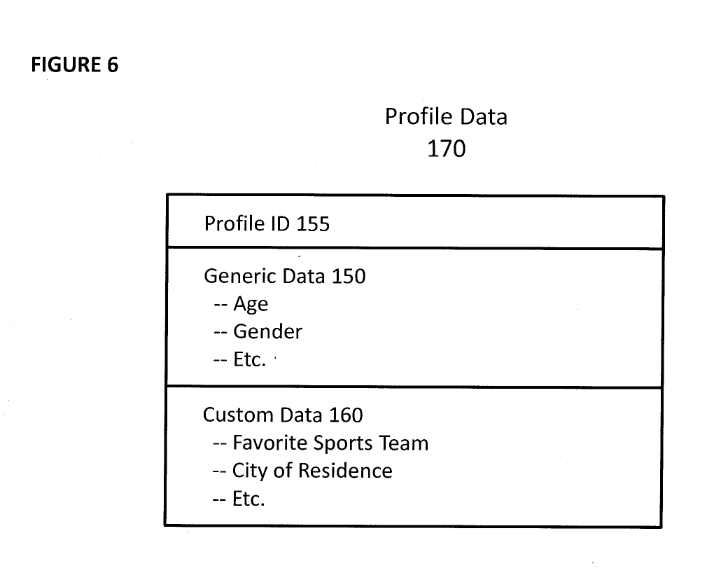

FIG. 6 depicts an exemplary embodiment of profile data 170. Profile data 170 can be stored in a data structure, such as in a table within a relational database such as a MySQL database. Profile Data 170 comprises data structures including generic data 150 and custom data 160. Profile data 170 optionally can be stored in a relational database, as discussed previously.

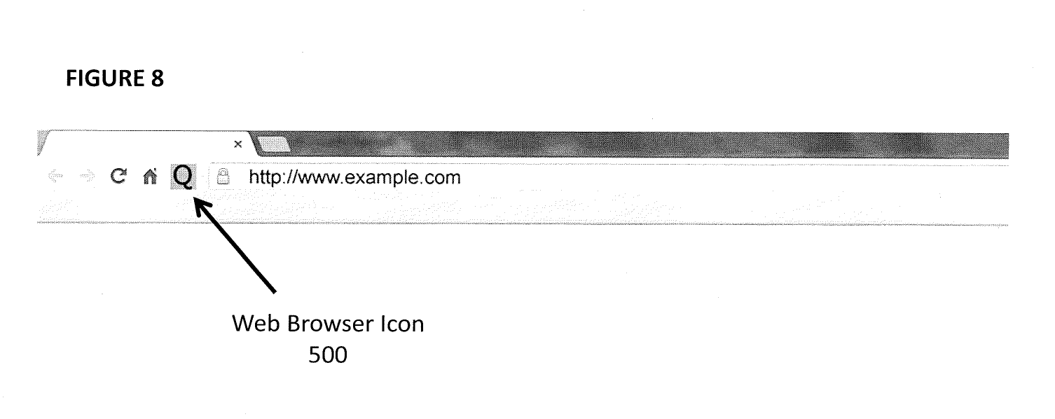

With reference to FIG. 8, when User 15 accesses web site 410 using web browser 110 on client 10, web browser 110 optionally can display web browser icon 500 that signifies that the web site 410 is a registered web site 415. User 15 optionally can click on web browser icon 500 to edit the parameters. If User 15 clicks on web browser icon 500, user interfaces such as user interface 200 and user interface 250 as shown in FIGS. 3 and 4 can be used to collect the new data.

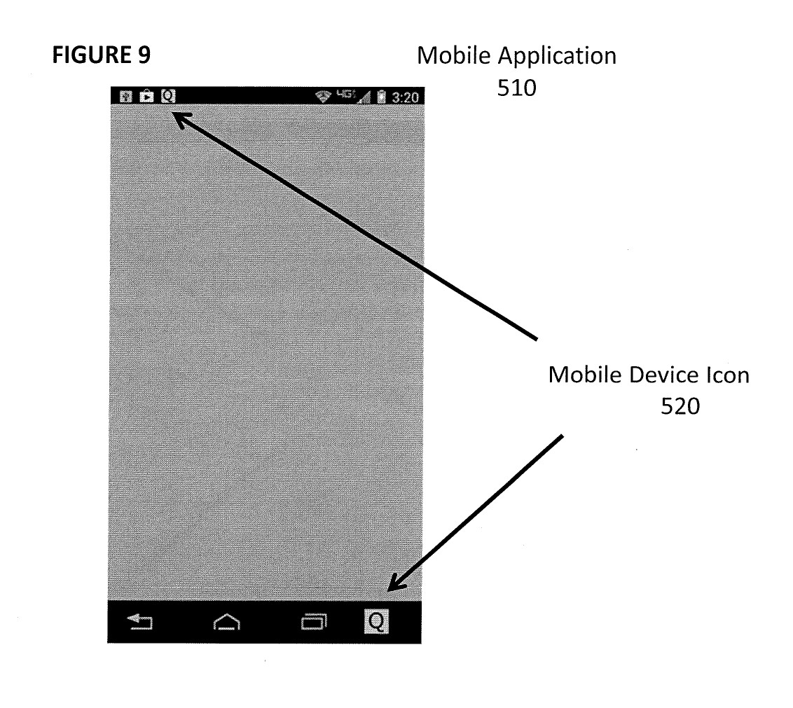

One of ordinary skill in the art will appreciate that client 10 can access web server 420 without using web browser 110. With reference to FIG. 9, if client 10 is a mobile device (such as a smartphone or tablet) and if User 15 accesses web server 420 using an application 510 other than a web browser (such as a native mobile application), then mobile application icon 520 can be displayed. Mobile application icon 520 signifies that the web server 420 is a registered web server 425. User 15 optionally can click on mobile application icon 520 to edit the parameters. If User 15 clicks on mobile application icon 520, user interfaces such as user interface 200 and user interface 250 as shown in FIGS. 3 and 4 can be used to collect the new data. This embodiment would be useful to tailor advertisements, or to provide certain content or suggest certain content, for User 15 according to Profile Data 170 when User 15 is operating an application on client 10.

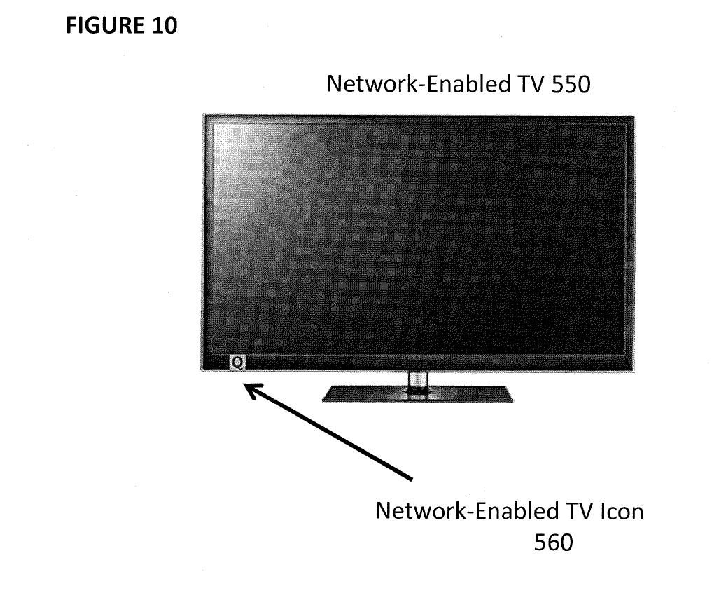

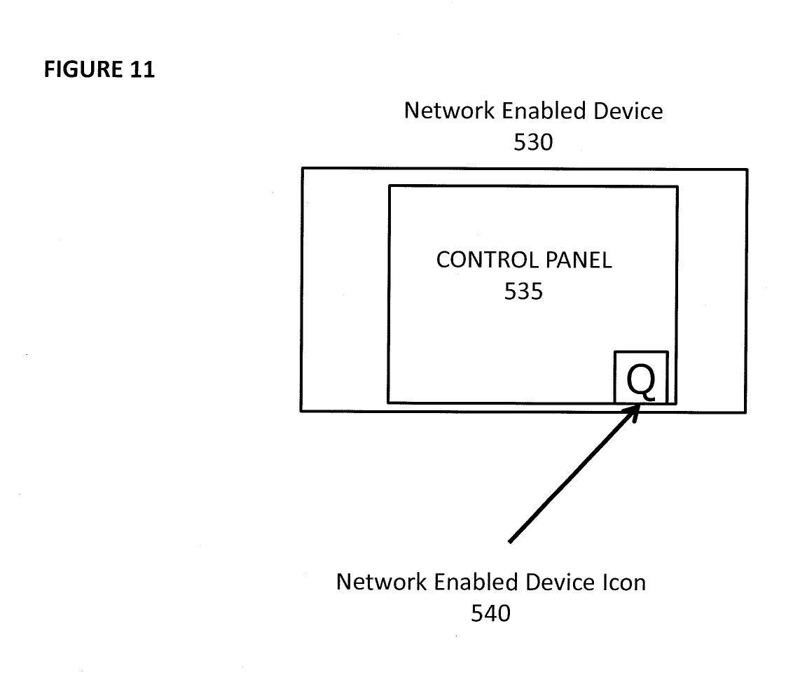

With reference to FIG. 10, if client 10 is a network enabled TV 550 and if the User accesses web server 420 with network enabled TV 550, then network enabled TV icon 560 can be displayed on the screen of network enabled device TV 550. In this situation, web server 420 typically will provide a “TV channel” to client 10. Network enabled TV icon 560 signifies that the web server 420 is a registered web server 425. User 15 optionally can select network enabled TV icon 560 to edit the parameters. If User 15 clicks on network enabled TV icon 560, user interfaces such as user interface 200 and user interface 250 as shown in FIGS. 3 and 4 can be used to collect the new data. This embodiment would be useful to tailor advertisements, or to provide certain content or suggest certain content, for User 15 according to Profile Data 170. With reference to FIG. 11, if client 10 is any network enabled device 530 (such as the network enabled TV 550, or another network enabled device such as a car) and if the client 10 accesses web server 420 with the network enabled device 530, then network enabled device icon 540 can be displayed on control panel 535 of network enabled device 530. Network enabled device icon 540 signifies that the web server 420 is a registered web server 425. User 15 optionally can click on network enabled device icon 540 to edit the parameters. If User 15 clicks on network enabled device icon 540, user interfaces such as user interface 200 and user interface 250 as shown in FIGS. 3 and 4 can be used to collect the new data. This embodiment would be useful to tailor advertisements or other content for User 15 according to Profile Data 170.

The characteristics of icons 500, 520, 540, and 560 can be altered to convey information to the user. For example, if icon 500, 520, 540, or 560 is one color (e.g., green), that color can be used to indicate that the parameters set by the user in Profile Setup Extension 120 are being utilized by registered web site 415 or registered web server 425. If icon 500, 520, 540, or 560 is a different color (e.g., orange), that color can be used to indicate that custom parameters are available from server 40. In this instance, User 15 may decide to click on the icon to edit the parameters (such as by adding in the information requested by custom parameters). If web site 410 is not a registered web site 415 and/or web server 420 is not a registered web server 425, then icon 500, 520, 540, and 560 optionally could be displayed as a third color (e.g., red) or could not be displayed. One of ordinary skill in the art that characteristics other than color can be used to convey this information through icons 500, 520, 540, and 560, such as size, font, blinking/steady, an “X” or slash mark, or other graphical alterations to the icon itself.

One of ordinary skill in the art will understand that in the web browser embodiments discussed above, a user will be able to visit web site 410 and have that web site 410 automatically tailored to the interested of that user without the user needing to login in to web site 410 or to provide profile information to web site 410. Instead, the user inputs profile information in response to queries by the profile setup extension 120 within client 10, and that information is automatically sent to server 40 via profile server 30 when the user attempts to access web site 410 operated by server 40. This can create a seamless web experience for the user where web site 410 will be tailored to his or her interests.

One of ordinary skill in the art will understand that in the embodiments discussed above that do not utilize a web browser, User 15 will be able to interact with web server 420 and have the content from web server 420 automatically tailored to the interested of User 15 without User 15 needing to login in to web server 420 or to provide profile information to web server 420. Instead, User 15 inputs profile information in response to queries by the profile setup extension 120 within client 10, and that information is automatically sent to server 40 via profile server 30 when User 15 attempts to access web server 420 operated by server 40. This can create a seamless experience for User 15 where web server 420 will tailor content to his or her interests.

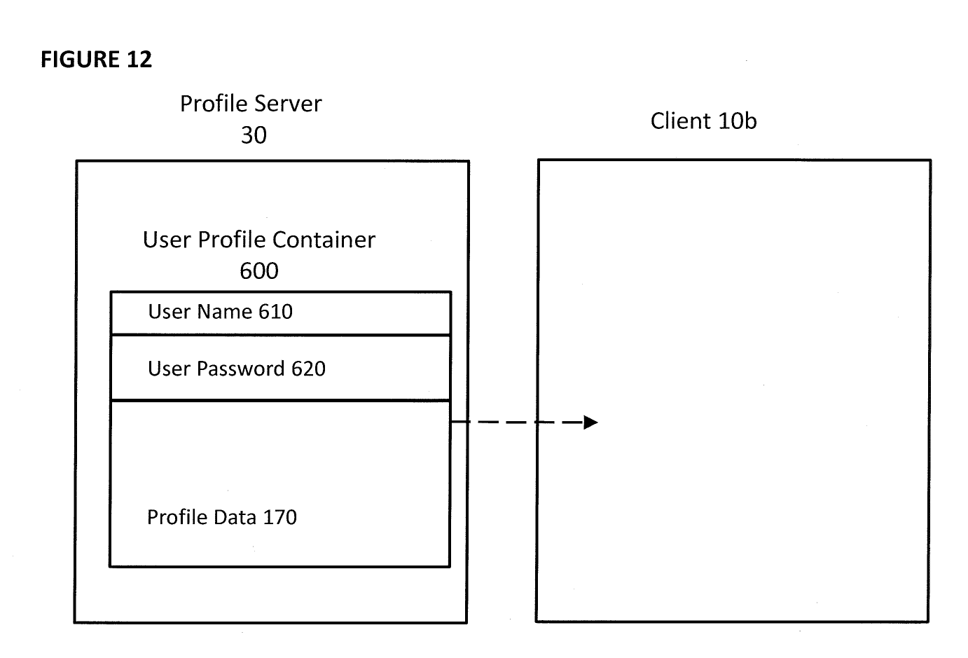

With reference to FIG. 12, an embodiment is shown to enable User 15 to move his or her profile data 170 from client 10a to client 10b (where client 10a and client 10b each are instances of client 10). Profile setup extension 120 on client 10a enables User 15 to establish a user name 610 and user password 620. That information is stored either in profile data 170 itself or with profile data 170 in user profile container 600. User profile container 600 is stored on client 10a and on profile server 30 Thereafter, when User 15 operates client 10b, profile setup extension 120 on client 10b can request user profile container 600 (or profile data 170) in response to User 15 entering user name 610 and user password 620, and thereafter client 10b can store user profile container 600 or (profile data 170) locally. This is beneficial to User 15 because he or she will not need to enter the profile data 170 all over again on client 10b and will be able to transfer it directly onto client 10b. User 15 then will be able to utilize client 10b to obtain the benefits of the embodiments described herein.

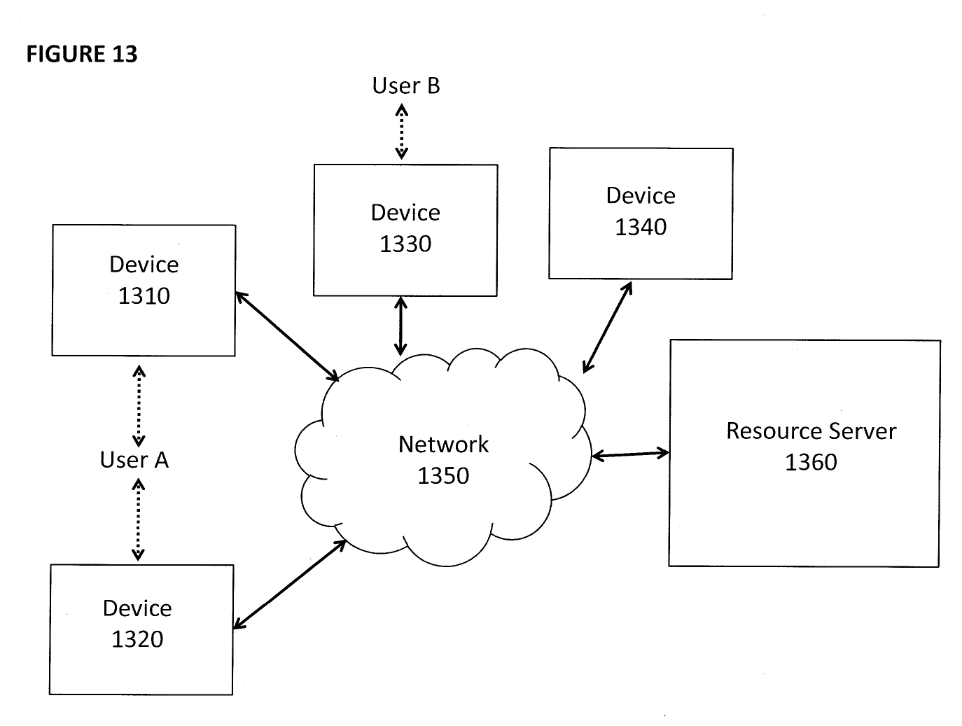

Embodiments for transferring authentication credentials from one device to another device, without the user needing to enter a user name and password, will now be described with reference to FIGS. 13-16.

With reference to FIG. 13, user A operates device 1310 and device 1320. User B operates device 1330. Device 1340 is not associated with a particular user at this time. Devices 1310, 1320, 1330, and 1340 each is a computer, such as a desktop, notebook, mobile device, tablet, appliance, or any other type of computing device that is network enabled. Devices 1310, 1320, 1330, and 1340 each comprise one or more processors, memory, non-volatile storage such as one or more hard disk drives and/or flash memory arrays, and a network interface. Devices 1310, 1320, 1330, and 1340 are coupled to network 1350 and can access resource server 1360 over network 1350. Network 1350 can be any type of network, such as the Internet, and can be hardwired, wireless, or some combination of the two. Resource server 1360 is a server that is network enabled and comprises one or more processors, memory, non-volatile storage such as one or more hard disk drives and/or flash memory arrays, and a network interface.

As described below, user A is able to share authentication credentials between device 1310 and device 1320 without needing to enter a username/password pair or a key pair by requesting temporary access rights to resource server 1360 through network 1350. Device 1310, 1320, 1330, and 1340 can operate as client 10 (described previously) but are not limited to client 10. Similarly, resource server 1360 can operate as profile server 30 (described previously) but is not limited to profile server 30.

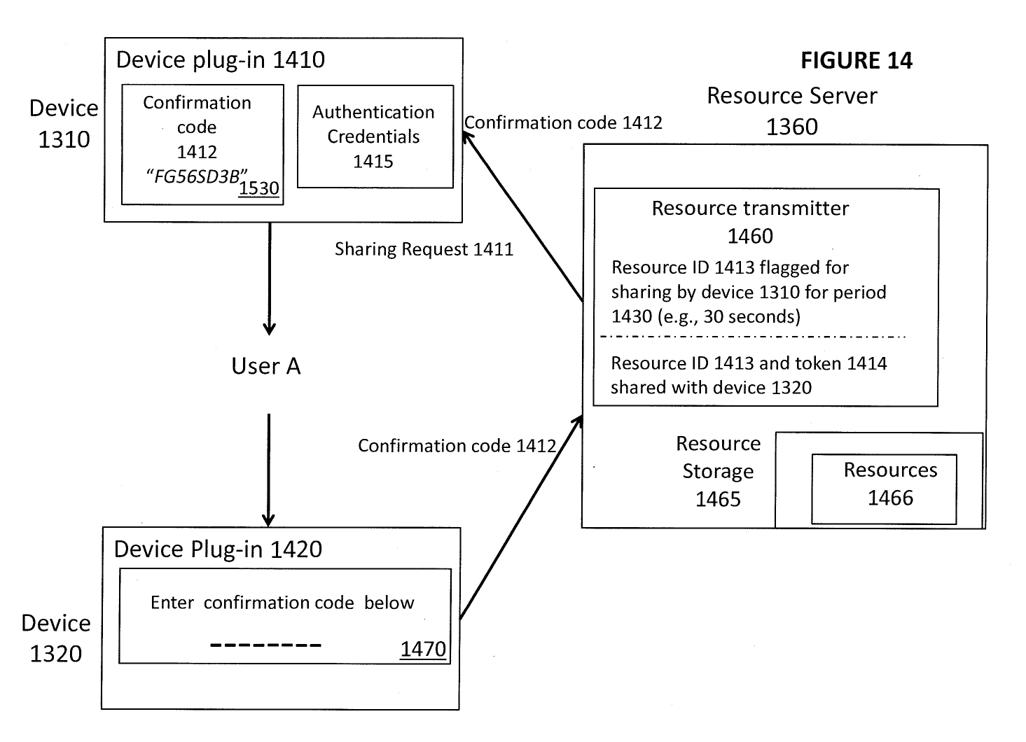

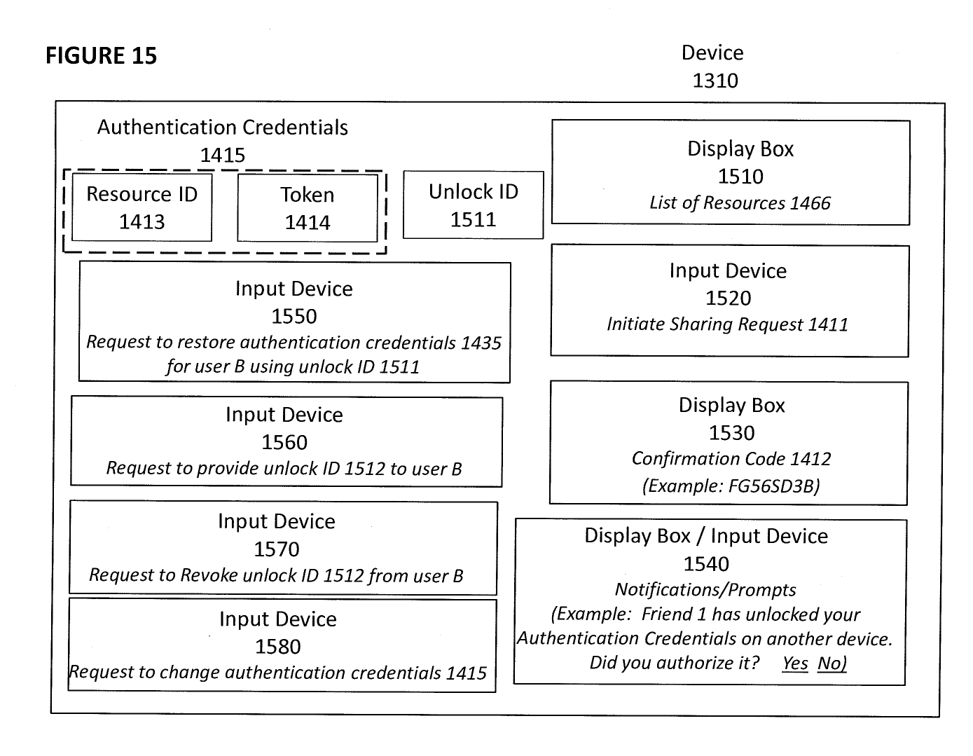

With reference to FIG. 14, device 1310 comprises device plug-in 1410, and device 1320 comprises device plug-in 1420. Device plug-ins 1410 and 1420 are lines of software code executed by one or more processors within devices 1310 and 1320, respectively. Device plug-in 1410 has stored authentication credentials 1415 locally in memory and/or non-volatile storage within device 1310. Authentication credentials 1415 can comprise resource ID 1413 and token 1414 (shown in FIG. 15). Resource server 1360 comprises resource transmitter 1460 and resource storage 1465. Resource transmitter 1460 communicates with devices such as devices 1310, 1320, 1330, and 1340 and manages access to resource storage 1465. Resource storage 1465 stores resources 1466 for users such as user A and user B. Resource storage 1465 comprises non-volatile storage such as one or more hard disk drives and/or one or more flash memory arrays. An example of resources 1466 is profile data 170 described previously with reference to FIG. 6. Resources 1466 can comprise any files or data accessible over the web. Other examples of resources 1466 include music data, video data, photo data, textual data, financial information, user names and passwords, PIN codes, and configuration data.

User A operates device 1310 to send sharing request 1411 through device plug-in 1410 to resource transmitter 1460. Sharing request 1411 is a request to share authentication credentials 1415 with another device, and sharing request 1411 includes within it authentication credentials 1415. Resource transmitter 1460 receives sharing request 1411, verifies authentication credentials 1415, and responds to sharing request 1411 by sending confirmation code 1412 to device 1410. Resource transmitter 1460 flags resource ID 1413 for sharing by device 1310 for period 1430 (e.g., 30 seconds).

User A views confirmation code 1412 on device 1310 using display box 1530 (shown also in FIG. 15), then enters confirmation code 1412 in device plug-in 1420 on device 1320 using input device 1470. Input device 1470 (such as a text box) is provided on a display device of device 1320 and can receive confirmation code 1412 from user A. Device plug-in 1420 then sends confirmation code 1412 to resource transmitter 1460, and resource transmitter 1460 checks to see if the resource ID corresponding to confirmation code 1412 (i.e., resource ID 1413) is flagged for sharing, and if it is, resource transmitter 1460 sends authentication credentials 1415 to device plug-in 1420. Device 1320 then stores authentication credentials 1415 locally in memory and/or non-volatile storage, and thereafter device 1320 can obtain access to resources 1466 associated with authentication credentials 1415 in resource storage 1465.

With reference to FIG. 15, user interface features and related functionality provided by device plug-in 1410 on device 1310 are depicted Device plug-in 1420 can provide the same user interface features and related functionality on device 1320.

Device 1310 stores authentication credentials 1415 locally in memory and/or non-volatile storage and comprises resource ID 1413 and token 1414.

Display boxes 1510, 1530, and 1540 are displayed on a display device of device 1310. Input devices 1520, 1540, 1550, 1560, 1570, and 1580 (such as text boxes, buttons, pull-down menus, or sliding-scale devices, etc.) are provided on a display device of device 1310 and can receive input from user A. Display box/input device 1540 is both a display box and an input device.

Display box 1510 depicts a listing of the resources 1466 accessible by device 1310.

Input device 1520 allows user A to cause device 1310 to send sharing request 1411 to resource server 1360 to share authentication credentials 1415 with another device, as described previously with reference to FIG. 14.

Display box 1530 displays confirmation code 1412 when it is returned by resource server 1360 in response to sharing request 1411, as described previously with reference to FIG. 14.

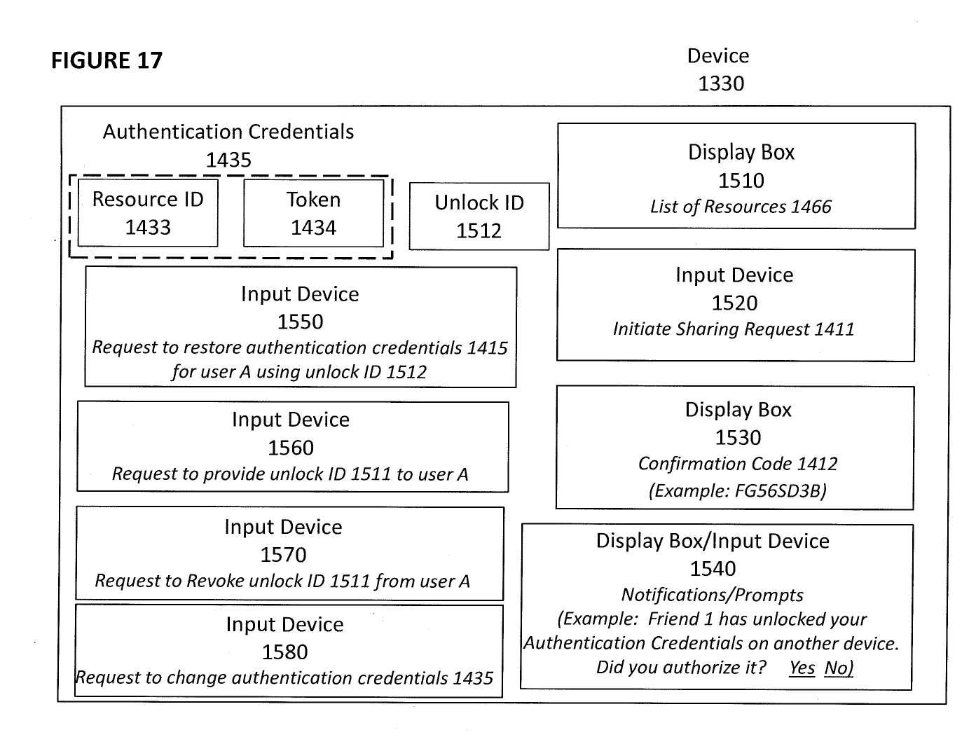

Input device 1550 allows user A to send a request to resource server 1360 to allow authentication credentials (of the same structure as authentication credentials 1415) for user B to be installed and utilized from another device (for example, device 1340) using a confirmation code (of the same type as confirmation code 1412). This is a useful feature if user B's device that stored his or her authentication credentials (for example, device 1330) is lost or stolen. For example, if user B loses device 1330, user A could access resource server 1360 using device 1310. User B will previously have instructed resource server 1360 to install an unlock ID 1511 on device 1310, and unlock ID 1511 will be installed on device 1310 in memory and/or non-volatile storage. User A and User B might be friends or family members and may want the other to have an unlock ID in case their device is lost or stolen. Upon losing device 1330, user B asks user A to use input device 1550 to contact resource server 1360, which results in device 1310 sending unlock ID 1511 to resource server 1360. In this example, device 1330 had stored locally in memory and/or non-volatile storage its authentication credentials 1435 comprising resource ID 1433 and token 1434 (shown in FIG. 17, discussed below).

Resource server 1360 maintains a relation table in resource transmitter 1460 that links unlock ID 1511 with resource ID 1433 of device 1330 and resource ID 1413 of device 1310 Resource server 1360 confirms that unlock ID 1511 is associated with resource ID 1413 of device 1310 (which is the device that sent the request) and provides confirmation code 1432. User A provides confirmation code 1432 to user B. User B then inputs confirmation code 1432 in device plug-in (of the same type as device plug-in 1410 and device plug-in 1420) of device 1340. Resource server 1360 receives confirmation code 1432 and then installs authentication credentials 1435 on device 1340. Thus, user B is able to install his or her authentication credentials 1435 on a new device (device 1340) after the loss of theft of device 1330.

With reference again to FIG. 15, display box/input device 1540 displays notifications and prompts. For instance, in the example of the preceding paragraph, if resource server 1360 receives a request to restore authentication credentials 1415 from device 1330, resource server 1360 can ask device 1310 if user A actually authorized that action. If user A did not authorize that action, then user A can say no through display box/input device 1540, and resource server 1360 can then deny the request from device 1330 by sending a message to device 1330 without a confirmation code. If user A actually did authorize the action, then device 1310 likely has been lost or stolen, and user A will not respond to the prompt in display box/input device 1540. In that event, resource server 1360 can wait a predetermined period of time (e.g., 30 minutes), and then having received no response, can proceed with the restoration process for authentication credentials 1415.

Input device 1550 allows user A to request to restore authentication credentials 1435 for user B using unlock ID 1511, which is the process described above.

Input device 1560 allows user A to request to provide unlock ID 1512 to user B, which is the unlock ID that will allow user B to restore user A's authentication credentials 1415 if device 1310 is lost or stolen.

Input device 1570 allows user A to revoke unlock ID 1512 from user B.

Input device 1580 allows user A to request to change authentication credentials 1415. In response to that request, resource transmitter 1460 will change resource ID 1413 and token 1414 in its own database as well as locally within device 1310. Following that change, resources 1466 will only be accessible by device 1310. Any previous unlock IDs installed on other devices at the request of user A will become ineffective. Any other device that contains the previous versions of resource ID 1413 and token 1414 will now be denied access to resources 1466 since that device no longer contains the current resource ID 1413 and token 1414. The user could then share the new authentication credentials 1415 with other devices and install unlock IDs on other devices if he or she chooses to do so.

With reference to FIG. 17, user interface features and related functionality provided by device plug-in 1430 on device 1330 used by user B are depicted. Many of the features and related functionality are the same as discussed previously for FIG. 15 and will not be repeated here. Notably, device 1330 stores locally its own authentication credentials 1435 comprising resource ID 1433 and token 1434, and also stores unlock ID 1512 for user A (in case user A's device is lost or stolen and user A needs to restore authentication credentials 1415).

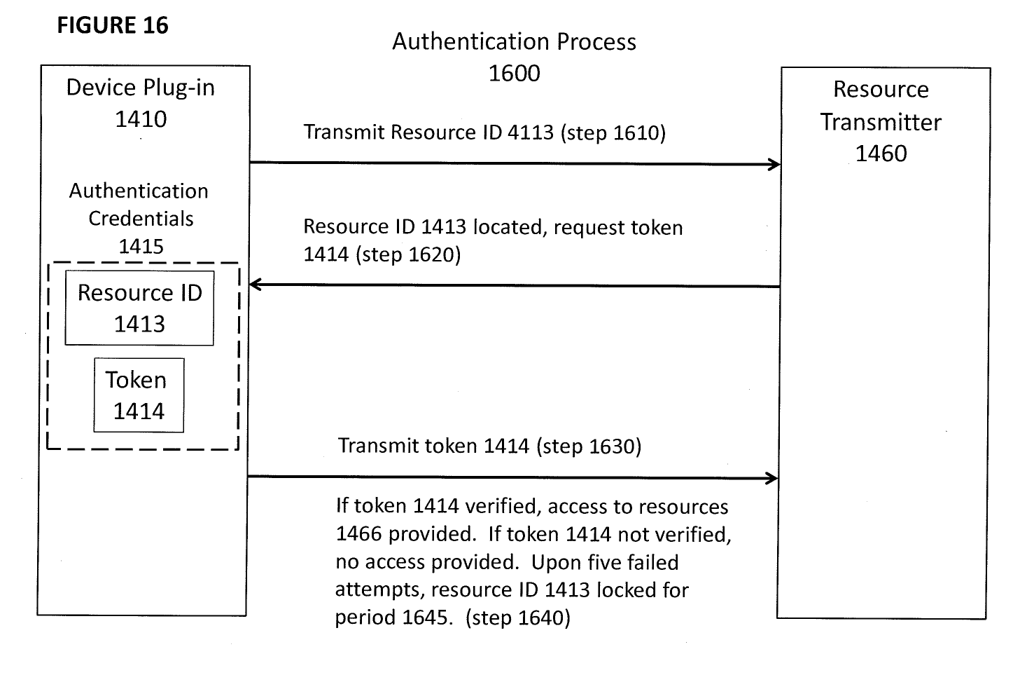

With reference to FIG. 16, authentication process 1600 is depicted. Authentication process 1600 allows a device to be authenticated to resource server 1360 through the use of authentication credentials and without requiring a user to enter a user name and password.

In this example, device 1310 stores resource ID 1413 in encrypted form and token 1414 in encrypted form, which together are an example of authentication credentials 1415. Device plug-in 1410 transmits resource ID 1413 to resource transmitter 1460 (step 1610). Step 1610 can occur automatically (for example, when device 1310 is booted up or when device 1310 first obtains connectivity to network 1350). Notably, step 1610 can occur without user A entering a user name or password for resource server 1360.

Resource server 1360 searches for resource ID 1413 within its list of valid resource IDs. If it finds it, it requests device 1310 to provide token 1414 (step 1620).

Device plug-in 1410 then provides token 1414 to resource transmitter 1460 (step 1630).

If token 1414 is verified by resource server 1360, then device 1310 is provided access to the resources associated with resource ID 1413 within resources 1466. If not, then after five failed attempts, resource ID 1413 is locked for a time period 1645 (step 1640). An example of time period 1645 is five minutes. This prevents fraudulent attempts to obtain access to resources 1466 through a “brute force” method.

One of ordinary skill in the art will appreciate that the above embodiments allow authentication credentials to be transferred to another device with assistance from a resource server. The embodiments do not require a user to enter a user name and password to access resource server. Instead, the authentication credentials that are stored locally on a first device are used to verify and initiate the transfer of the authentication credentials on a second device.

References to the present invention herein are not intended to limit the scope of any claim or claim term, but instead merely make reference to one or more features that may be covered by one or more of the claims. Materials, processes and numerical examples described above are exemplary only, and should not be deemed to limit the claims. It should be noted that, as used herein, the terms “over” and “on” both inclusively include “directly on” (no intermediate materials, elements or space disposed there between) and “indirectly on” (intermediate materials, elements or space disposed there between). Likewise, the term “adjacent” includes “directly adjacent” (no intermediate materials, elements or space disposed there between) and “indirectly adjacent” (intermediate materials, elements or space disposed there between).

What is claimed is:

1. A method for transferring authentication credentials, comprising:
receiving, by a resource server, a request from a first client device to transfer authentication credentials, wherein the authentication credentials provides access to a resource stored by the resource server;
providing, by the resource server, a confirmation code to the first client device;
receiving, by the resource server, the confirmation code from a second client device;
installing, by the resource server, the authentication credentials on the second client device.

2. The method of claim 1, wherein the authentication credentials comprises a resource ID and a token, the resource ID associated with the resource stored by the resource server.

3. The method of claim 2, further comprising:
flagging, by the resource server, the resource ID for a predetermined period of time to enable sharing of the authentication credentials within the predetermined period of time, wherein the installing step is performed only if the receiving step occurs during the predetermined period of time.

4. The method of claim 3, wherein the predetermined period of time is 30 seconds or less.

5. The method of claim 1, wherein the resource comprises user profile data.

6. The method of claim 1, wherein the resource comprises photo data.

7. The method of claim 1, wherein the resource comprises financial data.

8. A method for restoring authentication credentials, comprising:
receiving, by a resource server, a request from a first client device to provide an unlock ID for the first client device;
providing, by the resource server, the unlock ID to a second client device;
receiving, by the resource server, a restoration request from the second client device to restore authentication credentials for the first client device, the restoration request comprising the unlock ID;
providing, by the resource server, a confirmation code to the second client device;
receiving, by the resource server, the confirmation code from a third client device; and
installing, by the resource server, the authentication credentials on the third client device;

9. The method of claim 8, wherein the authentication credentials comprises a resource ID and a token, the resource ID associated with the resource stored by the resource server.

10. The method of claim 9, further comprising:
flagging, by the resource server, the resource ID for a predetermined period of time to enable sharing of the authentication credentials within the predetermined period of time, wherein the installing step is performed only if the resource server receives the confirmation code during the predetermined period of time.

11. The method of claim 10, wherein the predetermined period of time is 30 seconds or less.

12. The method of claim 8, wherein the resource comprises user profile data.

13. The method of claim 8, wherein the resource comprises photo data.

14. The method of claim 8, wherein the resource comprises financial data.

15. A method for restoring authentication credentials, comprising:
receiving, by a resource server, a request from a first client device to provide an unlock ID for the first client device;
providing, by the resource server, the unlock ID to a second client device;
receiving, by the resource server, a restoration request from the second client device to restore authentication credentials for the first client device, the restoration request comprising the unlock ID;
prompting, by the resource server, a user associated with the first client device whether the authentication credentials should be restored;
if the resource server receives an affirmative response from the user or receives no response within a first predetermined period of time:
providing, by the resource server, a confirmation code to the second client device;
receiving, by the resource server, the confirmation code from a third client device; and
installing, by the resource server, the authentication credentials on the third client device; and
if the resource server receives a negative response from the user, transmitting a message to the second client device without a confirmation code.

16. The method of claim 15, wherein the authentication credentials comprises a resource ID and a token, the resource ID associated with the resource stored by the resource server.

17. The method of claim 16, further comprising:
flagging, by the resource server, the resource ID for a second predetermined period of time to enable sharing of the authentication credentials within the second predetermined period of time, wherein the installing step is performed only if the resource server receives the confirmation code during the second predetermined period of time.

18. The method of claim 17, wherein the second predetermined period of time is 30 seconds or less.

19. The method of claim 15, wherein the resource comprises user profile data.

20. The method of claim 15, wherein the resource comprises photo data.

21. The method of claim 15, wherein the resource comprises financial data.
